(19) United States
(12) Patent Application Publication
(10) Pub. No.: US 2018/0171163 A1
(43) Pub. Date: Jun. 21, 2018

(54) MATTE SHEET AND MATTE PRODUCT MADE THEREFROM

(71) Applicant: FAR EASTERN NEW CENTURY CORPORATION, Taipei City (TW)

(72) Inventors: Kuan-Liang WEI, Taipei City (TW); Tsang-Pin CHEN, Taipei City (TW)

(73) Assignee: FAR EASTERN NEW CENTURY CORPORATION, Taipei City (TW)

(21) Appl. No.: 15/641,393

(22) Filed: Jul. 5, 2017

(30) Foreign Application Priority Data
Dec. 16, 2016 (TW) 105141688

(51) Int. Cl. C09D 7/00; B05D 3/04; C09D 157/06; C09D 7/12

(52) U.S. Cl. CPC C09D 7/005; C09D 7/1283; C09D 157/06; B05D 3/0493

(57) ABSTRACT

A matte sheet includes a substrate and a matte coating layer. The matte coating layer is formed on the substrate. The matte coating layer has an average thickness ranging from 2.5 μm to 6 μm and is made from a coating composition that includes a matting agent. The matte coating layer satisfies an inequality formula of 5<d₅₀/Ra≤11. D₅₀ stands for a particle size distribution of the matting agent and Ra stands for a roughness of the matte coating layer. The matte product made from the matte sheet is also provided.

### CROSS-REFERENCE TO RELATED APPLICATION

This application claims priority of Taiwanese Invention Patent Application No. 105141688, filed on Dec. 16, 2016.

### FIELD

The disclosure relates to a matte sheet, and more particularly to a matte sheet including a matte coating layer that has a predetermined thickness range and a predetermined ratio of a roughness of the matte coating layer and a particle size distribution of a matting agent included in the matte coating layer.

### BACKGROUND

Many conventional polymer substrates have relatively high surface gloss, such as those made from polystyrene (PS), polymethyl methacrylate (PMMA), polyethylene terephthalate (PET), etc., and have to be subjected to a conventional matting treatment before applied to fabrication of low surface gloss products. However, the conventional matting treatment of the polymer substrates, such as addition of an additive (e.g., rubber, a matting agent, etc.) into the polymer substrates or surface embossing of the polymer substrates before forming the matte product, the resulting polymer substrates tend to have relatively low wear resistance and relatively low mechanical strength. In order to improve the wear resistance of the matte product, it is proposed to apply a matte coating layer with a rough surface to surfaces of the polymer substrates. The matte coating layer is made from a composition that includes a matting agent, a resin and a cross-linking agent. When light is incident upon the rough surface of the matte coating layer, the light will be diffused so that the polymer substrates may have relatively low surface gloss.

As for evaluating gloss of a material, if a material has a 60° gloss less than 10 GU, it will be evaluated as “low gloss.” Furthermore, if the material is presumed to have a much lower gloss, an 85° gloss measurement is applied to the material. At a predetermined measurement angle, the lower the obtained gloss value, the lower the gloss of the material.

U.S. Patent Application Publication No. 20130131268 A1 discloses a radiation curable liquid coating composition that includes a multifunctional (meth)acrylated oligomer, C₈ to C₂₀ monofunctional aliphatic alkyl (meth)acrylate, a monomeric reactive diluent, and a matting agent. A coating layer that is made from the radiation curable liquid coating composition has a 60° gloss less than 15 GU, and has an 85° gloss not greater than 80 GU. The coating layer based on the acrylic acid-based composition of this patent can be dried quickly and polished and has chemical resistance. However, this patent is silent on making an improvement on surface gloss by means of adjustment of a particle size of the matting agent and roughness of a surface of the coating layer.

U.S. Patent Application Publication No. 20100035026 A1 discloses a low gloss sheet that includes a substrate and a coating layer formed on the substrate. The coating layer has 1 wt % of a filling agent, and has a 60° gloss less than 20 GU. However, such gloss value of the coating layer needs to be improved so as to be applied to products requiring much lower gloss, such as those with an 85° gloss.

Therefore, there is still room for improvement in gloss and other surface properties of the matte sheet for low gloss products.

### SUMMARY

Therefore, an object of the disclosure is to provide a matte sheet that can alleviate at least one of the drawbacks of the prior art.

According to one aspect of the disclosure, the matte sheet includes a substrate and a matte coating layer formed on the substrate.

The matte coating layer has an average thickness ranging from 2.5 μm to 6 μm and is made from a coating composition that includes a matting agent. The matte coating layer satisfyies an inequality formula of 5<d₅₀/Ra≤11, in which d₅₀ stands for a particle size distribution of the matting agent and Ra stands for a roughness of the matte coating layer.

According to another aspect of the disclosure, a matte product has an 85° gloss ranging from 6 GU to 24 GU, and is made from the abovementioned matte sheet through forming techniques.

### DETAILED DESCRIPTION

An embodiment of a matte sheet according to the disclosure includes a substrate, and a matte coating layer that is formed on the substrate.

The substrate may be made from a polymer material selected from polyester, polycarbonate, polyolefin, polyamide, etc., and may have a thickness ranging between 0.3 mm and 1.8 mm.

The matte coating layer is formed on a surface of the substrate, and is made from a coating composition including a matting agent. More specifically, the coating composition further includes a resin component and a cross-linking agent in addition to the matting agent.

Species and properties of the resin component are unlimited and depend upon required properties of the intended matte product made therefrom. Non-limiting examples of the resin component include polyurethane, polyester, polymethyl acrylate, and combinations thereof. In one form, due to environmental concerns, the resin component may be a waterborne resin so as to reduce or avoid use of organic solvents. Non-limiting examples of the waterborne resin include waterborne polyurethane, waterborne polyester, waterborne polymethyl acrylate, and combinations thereof.

The matting agent included in the coating composition of the matte coating layer is in particulate form to make the matte coating layer to have a rough surface. Thus, light emitting on the rough surface of the matte coating layer will be diffused so that the resulting matte sheet has relatively low gloss. The matting agent unlimitedly includes an inorganic matting agent, such as mineral particles, etc., an organic matting agent, such as resin particles, etc., or combinations thereof. In one form, the mineral particles serve as the matting agent, and are exemplified to be silicon dioxide particles. The commercial products of the silicon dioxide particles include Sunsphere® Series-H products available from Asahi Glass Co., Ltd., Japan, such as SUNSPHERE® H-51 and SUNSPHERE® H-121. In one form, the matting agent has a particle size distribution (d₅₀) ranging from 5 μm to 8 μm. The matte coating layer satisfies an inequality formula of 5<d₅₀/Ra≤11, in which Ra stands for a roughness of the matte coating layer. Thus, the matte coating layer is evenly coated on the substrate and has a relatively great matting effect. In one form, the particle size distribution (d₅₀) of the matting agent ranges between 5.5 μm and 7.5 μm, so that the surface roughness of the matte coating layer can be improved, and that the coating composition cannot be easily sedimentated or aggregated. In one form, the matting agent may be in an amount ranging from 10 parts to 20 parts by weight based on 100 parts by weight of the waterborne resin. Therefore, the matting agent can be uniformly dispersed in the coating composition, and the matte coating layer thus formed can have relatively great matting effect and abrasion resistance.

The cross-linking agent is used for mixing with the resin component to carry out formation of cross-links therebetween. Types and an amount of the cross-linking agent are unlimitedly adjustable based on the selected resin component. Non-limiting examples of the cross-linking agent include aziridine-based cross-linking agents, carbodiimide-based cross-linking agents, isocyanate-based cross-linking agents, silane-based cross-linking agents, etc. A non-limiting example of a commercial product of the aziridine-based cross-linking agents is CX-100 ® (available from Koninklijke DSM N.V.). The cross-linking agent may unlimitedly be in an amount ranging between 1 part by weight and 10 parts by weight based on 100 parts by weight of the resin component. Preferably, the amount of the cross-linking agent ranges between 3 parts and 5 parts by weight based on 100 parts by weight of the resin component.

The coating composition may further include a solvent or at least one functional additive based on actual applications. A non-limiting example of the solvent is water, and non-limiting examples of the functional additive include a leveling agent, a dispersant, a defoamer, etc. The coating composition may include one or more types of the functional additives. An amount of the functional additive is adjustable based on actual applications. The amount of the functional additives may range from greater than 0 to 5 parts by weight based on 100 parts by weight of the resin component.

A method of making the coating composition may include mixing the resin component, the matting agent, the cross-linking agent, the solvent and the optional functional additives until a stable viscosity is achieved.

A method of making the matte coating layer may include coating the coating composition on the surface of the substrate, and then curing the coating composition. Specifically, the curing step may be conducted using baking techniques. The solvent can be removed and the resin component and the cross-linking agent can be cross-linked during the baking process so as to form the matte coating layer from the cured coating composition.

In one form, the matte coating layer may have an average thickness ranging from 3 μm to 5.5 μm so as to have improved abrasion resistance and adhesion to the substrate.

In one form, the matte coating layer may have a roughness (Ra) ranging from 0.5 μm to 1.4 μm so that the gloss of the matte coating layer can be further reduced.

The matte product is made from the aforesaid matte sheet using forming techniques, such as vacuum forming techniques. The vacuum forming techniques may include heating and softening the matte sheet, placing the softened matte sheet over a mold, vacuum-stretching and shaping the softened matte sheet in the mold, and then cooling the shaped matte sheet to form the matte product. Heating and softening of the matte sheet may be conducted at a heating temperature ranging from 300° C. to 500° C. for a period of time ranging from 3 seconds to 30 seconds. The stretching force applied in the vacuum-stretching operation is controllable based on actual requests of the matte product. For example, the matte product may have a stretch ratio ranging from 1 to 4.

The matte sheet has an 85° gloss not greater than 15 GU. The matte product has an 85° gloss not greater than 25 GU.

In the following, the exemplary embodiments of the disclosure will be described in detail.

### Example 1—Fabrication of Matte Sheet

A resin component is prepared based on a composition shown in Table 1. The resin component is then mixed with a matting agent, a cross-linking agent and a dispersant based on the composition shown in Table 1 so as to obtain a reactant mixture. The reactant mixture is then stirred at a stirring speed ranging between 500 rpm and 1000 rpm until the reactant mixture has a stable viscosity so as to form a coating composition. The coating composition is then held in place for 4 hours and no sedimentation is observed.

Next, the coating composition is spread on a surface of a polyester substrate that has a thickness of 0.5 mm using a bar spreader. The polyester substrate and the coating composition coated thereon are baked together in an oven at a temperature of 70° C. for 2 minutes. The matte sheet that includes the polyester substrate formed with the matte coating layer is formed.

### Examples 2 to 6 and Comparative Examples 1 to 4—Fabrication of Matte Sheets

Matte sheets of Examples 2 to 6 and Comparative Examples 1 to 4 are made in a manner similar to that of Example 1 except that the dispersants and the matting agents are prepared in accordance with the compositions shown in Table 1.

Fabrication of Matte Products Based on the Matte Sheets Obtained from Examples 1 to 6 and Comparative Examples 1 to 5

The matte products are made from the matte sheets obtained from Examples 1 to 6 and Comparative Examples 1 to 4 through vacuum forming techniques. At first, the matte sheets obtained from Examples 1 to 6 and Comparative Examples 1 to 4 are respectively heated and softened at a temperature of 500° C. for 4.8 seconds, and the softened matte sheets are formed under vacuum in a vacuum forming machine (Model No. FASP6512, available from CHII KAE MACHINERY CO., LTD., Taiwan) until the softened matte sheets are shaped, followed by cooling of the shaped matte sheets to form the matte products.

Property Determination and Evaluation

1. Particle size distribution (d₅₀): the particle size distributions (d₅₀) of the matting agents respectively used in Examples 1 to 6 and Comparative Examples 1 to 4 are measured with a particle size analyzer (Model No. Coulter LS230, available from Beckman Coulter Inc., Fullerton, Calif., USA.) according to the analysis method of ISO 13320-1.

2. Average thickness of the matte coating layer: the average thicknesses of the matte coating layers respectively formed in Examples 1 to 6 and Comparative Examples 1 to 4 are measured using a scanning electron microscope (Model No. JSM-6390, manufactured by JEOL Ltd., Japan).

3. Roughness of the matte coating layer (Ra): roughness of the matte coating layers respectively formed in Examples 1 to 6 and Comparative Examples 1 to 4 is measured with a microfigure measuring instrument (Model No. ET4000A, manufactured by Kosaka Laboratory Ltd., Japan).

4. 85° gloss: the 85° gloss of the matte sheets of Examples 1 to 6 and Comparative Examples 1 to 4 and the matte products of Examples 1 to 6 and Comparative Examples 1 to 4 is measured at a gloss measurement angle of about 85° according to methods of ASTM D2457 and ASTM D523 with a gloss meter (Model No. GL0030, manufactured by TQC Therminport Quality Control B.V.). Low gloss matte sheets have the 85° gloss not greater than 15 GU and the matte products made therefrom have the 85° gloss not greater than 25 GU.

5. Adhesion: for each of the matte sheets of Examples 1 to 6 and Comparative Examples 1 to 4 and the matte product made therefrom, the adhesion of the matte coating layer to the substrate is measured according to the method of ASTM 3359. The adhesion of the matte coating layer to the substrate can be classified into the following levels:

5B: a ratio of a peeling area of the matte coating layer to a total area of the matte coating layer is 0, which represents the best adhesion of the matte coating layer to the substrate;

4B: a ratio of a peeling area of the matte coating layer to a total area of the matte coating layer is greater than 0 and less than 5%;

3B: a ratio of a peeling area of the matte coating layer to a total area of the matte coating layer is from 5% to less than 15%;

2B: a ratio of a peeling area of the matte coating layer to a total area of the matte coating layer is from 15% to less than 35%;

1B: a ratio of a peeling area of the matte coating layer to a total area of the matte coating layer is from 35% to less than 65%; and

0B: a ratio of a peeling area of the matte coating layer to a total area of the matte coating layer is not less than 65%, which represents the worst adhesion of the matte coating layer to the substrate.

6. Abrasion resistance: for each of the matte sheets of Examples 1 to 6 and Comparative Examples 1 to 4 and the matte product made therefrom, abrasion resistance of the matte coating layer is evaluated by measuring the difference between haze values of the matte coating layer before and after being rubbed with another matting coating layer of the same gloss. The haze value is measured according to the method of ASTM D1003 and can be classified into the following levels:

Symbol “◯”: the difference of the haze values before and after being rubbed is less than 0.5%, which represents the best abrasion resistance;

Symbol “Δ”: the difference of the haze values before and after being rubbed ranges between 0.5% and 1.5%; and

Symbol “x”: the difference of the haze values before and after being rubbed is greater than 1.5%, which represents the worst abrasion resistance.

TABLE 1

| | | | Example | | | | | | Comparative Example | | | |
|---|---|---|---|---|---|---|---|---|---|---|---|---|
| | | | 1 | 2 | 3 | 4 | 5 | 6 | 1 | 2 | 3 | 4 |
| Coating | Resin | A-1127 | 36 | | | | | | | | | |
| composition(parts) | Component | R-986 | 32 | | | | | | | | | |
| | | MD-1245 | 32 | | | | | | | | | |
| | | Total Amount | 100 | | | | | | | | | |
| | Cross-linking | CX-100 | 5 | | | | | | | | | |
| | agent | | | | | | | | | | | |
| | Dispersant | Dispers | 1 | 1 | 1 | 1.5 | 2.0 | 1.5 | 1 | 0.5 | 1 | 1 |
| | | 775 W | | | | | | | | | | |
| | Matting | H-51 | 9.3 | 6.4 | 6.4 | 13.95 | 18.6 | 9.6 | 9.3 | 3.2 | 9.3 | 6.4 |
| | agent | H-121 | 0.7 | 3.6 | 3.6 | 1.05 | 1.4 | 5.4 | 0.7 | 1.8 | 0.7 | 3.6 |
| | | total | 10 | 10 | 10 | 15 | 20 | 15 | 10 | 5 | 10 | 10 |

| Particle size distribution of the | | 5.5 | 7.5 | 7.5 | 5.5 | 5.5 | 7.5 | 5.5 | 7.5 | 5.5 | 7.5 |
|---|---|---|---|---|---|---|---|---|---|---|---|
| matting agent (d₅₀)(μm) | | | | | | | | | | | |
| Matte | average thickness | 3 | 3 | 5.5 | 5.5 | 5.5 | 5.5 | 5.5 | 5.5 | 1.5 | 1.5 |
| sheet | of the matting | | | | | | | | | | |
| | layer(μm) | | | | | | | | | | |
| | roughness of the | 0.66 | 1.21 | 0.80 | 0.52 | 0.53 | 0.92 | 0.48 | 0.62 | 0.70 | 1.31 |
| | matting layer | | | | | | | | | | |
| | (Ra)(μm) | | | | | | | | | | |
| | d₅₀/Ra | 8.33 | 6.20 | 9.38 | 10.58 | 10.38 | 8.15 | 11.46 | 12.10 | 7.86 | 5.73 |
| | 85° gloss (GU) | 9 | 4 | 9 | 14 | 12 | 5 | 23 | 32 | 4 | 1.5 |
| | adhesion | 5B | 5B | 5B | 5B | 5B | 5B | 5B | 5B | 0B | 0B |
| | abrasion resistance | Δ | ∘ | ∘ | Δ | Δ | ∘ | Δ | Δ | × | × |
| Matte | 85° gloss (GU) | 24 | 13 | 23 | 17 | 12 | 6 | 26 | 50 | 7 | 7 |
| product | adhesion | 5B | 5B | 5B | 5B | 5B | 5B | 5B | 5B | 2B | 2B |
| | abrasion resistance | Δ | Δ | Δ | Δ | Δ | ∘ | Δ | × | × | × |

*A-1127 is a waterborne resin available from Koninklijke DSM N.V., the Netherlands.
*R-986 is a waterborne resin available from Koninklijke DSM N.V., the Netherlands.
*MD-1245 is a waterborne resin available from TOYOBO CO., Japan.
*H-51 is a matting agent of the product SUNSPHERE ® H-51 available from Asahi Glass Co., Ltd., Japan, including silicon dioxide particles and having a particle size distribution (d₅₀) of 5 μm.
*H-121 is a matting agent of the product SUNSPHERE ® H-121 available from Asahi Glass Co., Ltd., Japan, including silicon dioxide particles and having a particle size distribution (d₅₀) of 12 μm.
*CX-100 is a cross-linking agent available from Koninklijke DSM N.V., the Netherlands.
*Dispers 775 W is the commercial product Tego ® 775 w available from Evonik Resource Efficiency GmbH.

According to the results shown in Table 1 relevant to Examples 1 to 6, by way of controlling the ratio of the particle size distribution (d₅₀) of the matte coating agent to the roughness (Ra) of the matte coating layer of each of the matte sheets to fall within 6.2 to 10.58, and the average thickness of the matte coating layer of each of the matte sheets to fall within 3 μm to 5.5 μm, the 85° gloss of each of the matte sheets can be controlled to range between 4 GU and 14 GU, and each of the matte coating layers can have great abrasion resistance and great adhesion to the substrate. Furthermore, the matte products that are respectively made from the matte sheets at a heating temperature of 500° C. and a draw ratio up to 3.3 during the vacuum forming process, have the 85° gloss ranging from 6 to 24. It demonstrates that the low gloss matte sheets of these examples and the matte products made therefrom have great adhesion to the substrates and acceptable or even great abrasion resistance.

According to the results shown in Table 1 relevant to Comparative Examples 1 and 2, the ratios of the particle size distribution (d₅₀) of the matting agent to the roughness (Ra) of the matte coating layers are respectively 11.46 and 12.10. The 85° gloss of the matte sheets are respectively 23 GU and 32 GU, and the 85° gloss of the matte products made from these matte sheets are respectively 26 GU and 50 GU. Regardless of whether the results of abrasion resistance or adhesion to the substrate for each of the matte sheets and each of the matte products made thereform are great or acceptable, the matte sheets and matte products made therefrom of Comparative Examples 1 and 2 fail to comply with the low gloss standard. Specifically, the matte product made from the matte sheet of Comparative Example 2 has relatively low abrasion resistance.

Furthermore, the average thickness of the matte coating layers of the matte sheets of Comparative Examples 4 and 5 is 1.5 μm, and adhesion to the substrate and abrasion resistances of the matte sheets and the matte products made therefrom of these Comparative examples are worse.

By virtue of the particle size distribution of the matting agent and the roughness of the matte coating layer satisfying the inequality formula of 5<d₅₀/Ra≤11, and the average thickness of the matte coating layer ranging from 2.5 μm to 6 μm, the matte sheet of the disclosure not only has low gloss with the 85° gloss being not greater than 15 GU but acceptable or even great adhesion to the substrate and abrasion resistance of the matte coating layer. Besides, the matte product made from the matte sheet of this disclosure also has low gloss with the 85° gloss not greater than 25 GU and acceptable or even great adhesion to the substrate and abrasion resistance of the matte coating layer.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, FIGURE, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A matte sheet, comprising:
a substrate; and
a matte coating layer formed on said substrate, said matte coating layer having an average thickness ranging from 2.5 μm to 6 μm and made from a coating composition that includes a matting agent;
wherein said matte coating layer satisfies an inequality formula of 5<d₅₀/Ra≤11,
in which d₅₀ stands for a particle size distribution of said matting agent and Ra stands for a roughness of said matte coating layer.

2. The matte sheet of claim 1, wherein the roughness (Ra) of said matte coating layer ranges from 0.5 μm to 1.4 μm.

3. The matte sheet of claim 1, wherein the particle size distribution (d₅₀) of said matting agent ranges from 5 μm to 8 μm.

4. The matte sheet of claim 1, wherein said coating composition further includes a resin component and a cross-linking agent.

5. The matte sheet of claim 4, wherein said matting agent is in an amount ranging from 10 parts to 20 parts by weight based on 100 parts by weight of said resin component.

6. The matte sheet of claim 1, which has a 85° gloss not greater than 15 GU.

7. A matte product, which has a 85° gloss ranging from 6 to 24 GU and is made from said matte sheet of claim 1 through forming techniques.

8. The matte product of claim 7, wherein the forming techniques are vacuum forming techniques.
